(19) United States
(12) Patent Application Publication
(10) Pub. No.: US 2013/0089426 A1
(43) Pub. Date: Apr. 11, 2013

(54) Rotor for Wind Power Installation

(71) Applicants: Vladimir Grigorievich Degtyar, Miass (RU); Vladimir Pavlovich Krivospitsky, Miass (RU); Valery Mikhailovich Kuznetsov, Miass (RU); Vasily Filippovich Maksimov, Miass (RU)

(72) Inventors: Vladimir Grigorievich Degtyar, Miass (RU); Vladimir Pavlovich Krivospitsky, Miass (RU); Valery Mikhailovich Kuznetsov, Miass (RU); Vasily Filippovich Maksimov, Miass (RU)

(21) Appl. No.: 13/806,236

(22) PCT Filed: Jun. 23, 2011
(86) PCT No.: PCT/RU11/00442

§ 371 Date: Dec. 21, 2012

(30) Foreign Application Priority Data
Jul. 2, 2010 (RU) 2010127573

(51) Int. Cl. F03D 3/06

(52) U.S. Cl. CPC F03D 3/062
USPC 416/205

(57) ABSTRACT

The proposed device relates to the field of wind power engineering and can be used as a rotor in wind power installations with a vertical axis of rotation. The rotor includes a central hub, a bearing ring, including a plurality of segments, and blades vertically mounted on the ring in two tiers. The ring is connected to the hub by flexible tensioning members supported by fastening assemblies, secured on the hub and vertically spaced apart. The flexible tensioning members connected to the upper fastening assemblies are length-adjustable. The flexible tensioning members connected to the lower fastening assemblies are equipped with turnbuckles. The fastening assemblies are equipped with rotatable plates having horizontal pivot pins, which are vertically spaced apart. The proposed device makes it possible to improve the balancing of rotor.

### CROSS-REFERENCES TO RELATED APPLICATIONS

This application is a U.S. national phase application of a PCT application PCT/RU2011/000442 filed on 23 Jun. 2011, published as WO/2012/002842, whose disclosure is incorporated herein in its entirety by reference, which PCT application claims priority of a Russian Federation patent application RU20101275730 filed on 2 Jul. 2010.

### FIELD OF THE INVENTION

The invention relates to the field of wind power engineering and can be used in wind power installations (plants) with a vertical axis of rotation.

### BACKGROUND OF THE INVENTION

There are known wind power installation with a vertical axis of rotation (see references [R1]-[R6] at the end of present description), generally comprising a central shaft, traverses, a bearing unit with vertical blades.

According to the invention described in a Russian Federation Patent RU2044157, an aero-hydro-dynamic engine is designed being multi-tiered with vertical blades hingedly mounted on axes that allows revolving the blades about the axes. A number of supports, being offset relatively to the centers of rotation of the axes, interact with the blades. A drawback of such design is that the blade is secured in one point only, while the attachment is not rigid, but hinged. During operation of such installation, the end of blade, that is not secured, will deviate from the vertical axis, producing oscillations, which may lead to failure of the hinged unit.

A wind installation rotor with a vertical rotation axis, being more relevant to the proposed invention, is described in a Russian Federation Patent RU2347104. The rotor of the vertical-axis wind power installation comprises a number of blades revolvable about the vertical axes, and a hub positioned in the rotation center; a plurality of power traverses enclosed in aero-dynamic fairings alternatively support the blades attached thereto; wherein the upwardly supported blades form an upper tier, while the downwardly supported blades form a lower tier.

A drawback of such design is that the mass center of the rotor does not necessarily coincide with the rotation axis thereof, which produces oscillations transferred to the mast, and the mast starts vibrating. Such vibrations may eventually destroy the installation. The rotor of a low power installation (less than 200 W) can be accurately balanced on the manufacturing plant and delivered being assembled, whereas the rotors of installations of higher power (e.g. 30 kW and more) are delivered to the construction site being de-assembled. The hub, traverses, blades, rings, and other units are transported separately, which may lead to misbalancing the installation after it's assembled, while rebalancing the installation on the construction site is practically impossible.

### BRIEF SUMMARY OF THE INVENTION

The primary aim of the present invention is the designing of a rotor, wherein a misbalance of the rotor is not transferred to the mast, but compensated by the structure of the rotor. This is achieved by providing a bearing ring that supports the blades, while the bearing ring is coupled with the hub by means of flexible tensioning members, for example, made of cable. Other aims and particular applications of the claimed invention may become apparent to one skilled in the art upon learning the present disclosure.

### BRIEF DESCRIPTION OF DRAWINGS

The substance of the present invention is illustrated by the following drawings:

FIG. 1 shows a general view of the rotor, according to a preferred embodiment of the present invention.

FIG. 2 shows a plan view (A) of the rotor, according to the preferred embodiment of the present invention shown in FIG. 1.

FIG. 3 shows a view (B) of the rotor from the underside, according to the preferred embodiment of the present invention shown in FIG. 1.

FIG. 4 shows a view (C) of a unit for attachment of the upper tensioning members to the hub, according to the preferred embodiment of the present invention shown in FIG. 1.

FIG. 5 shows a lateral view (G) of a unit for attachment of the blade to the bearing ring, according to the preferred embodiment of the present invention shown in FIG. 2.

FIG. 6 shows a sectional view (E) of a unit of attachment of segments of the bearing ring, according to the preferred embodiment of the present invention shown in FIG. 2.

FIG. 7 shows a sectional view (F) of a unit for attachment of the tensioning members to the bearing ring, according to the preferred embodiment of the present invention shown in FIG. 2.

FIG. 8 shows a sectional view (J-J) of a unit for alignment of the blades during the installation thereof, according to the preferred embodiment of the present invention shown in FIG. 7.

FIG. 9 shows a sectional view (I-I) of a unit for attachment of the blade, according to the preferred embodiment of the present invention shown in FIG. 7.

FIG. 10 shows a sectional view (G-G) of the upper and lower tensioning members, according to the preferred embodiment of the present invention shown in FIG. 2.

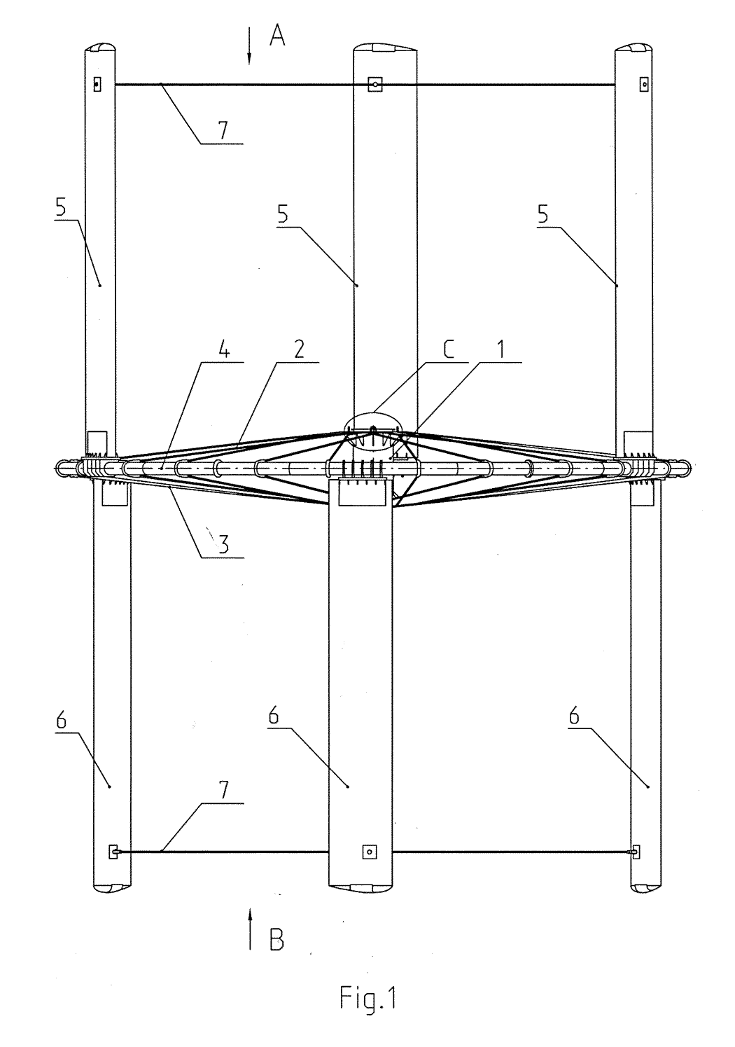

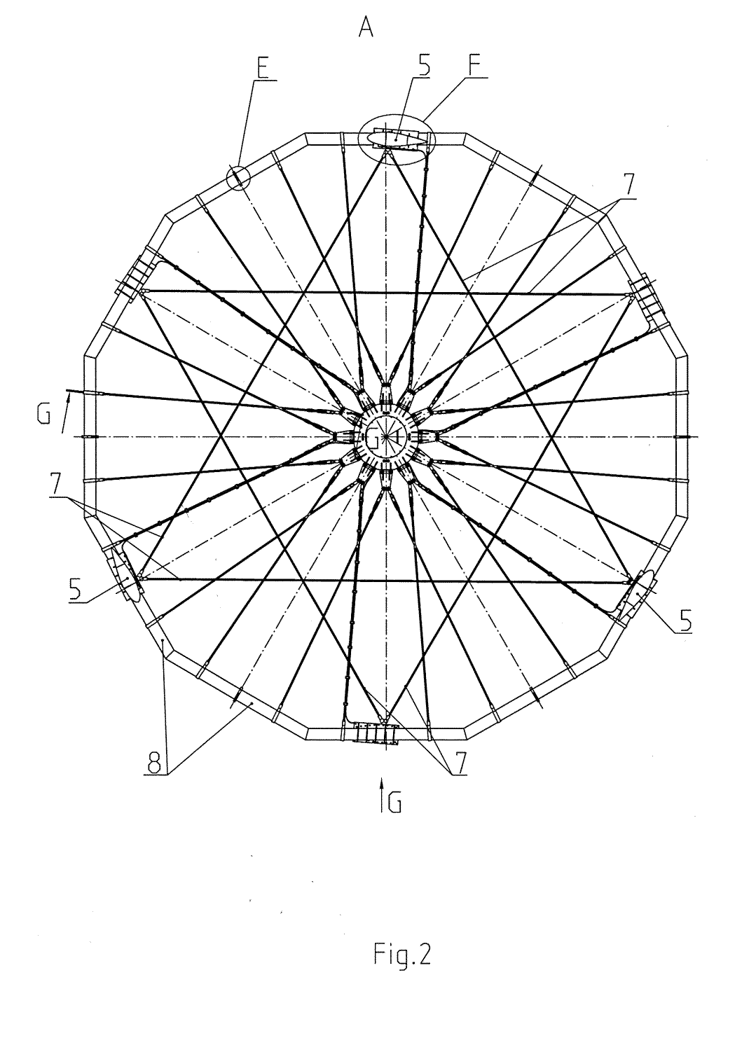

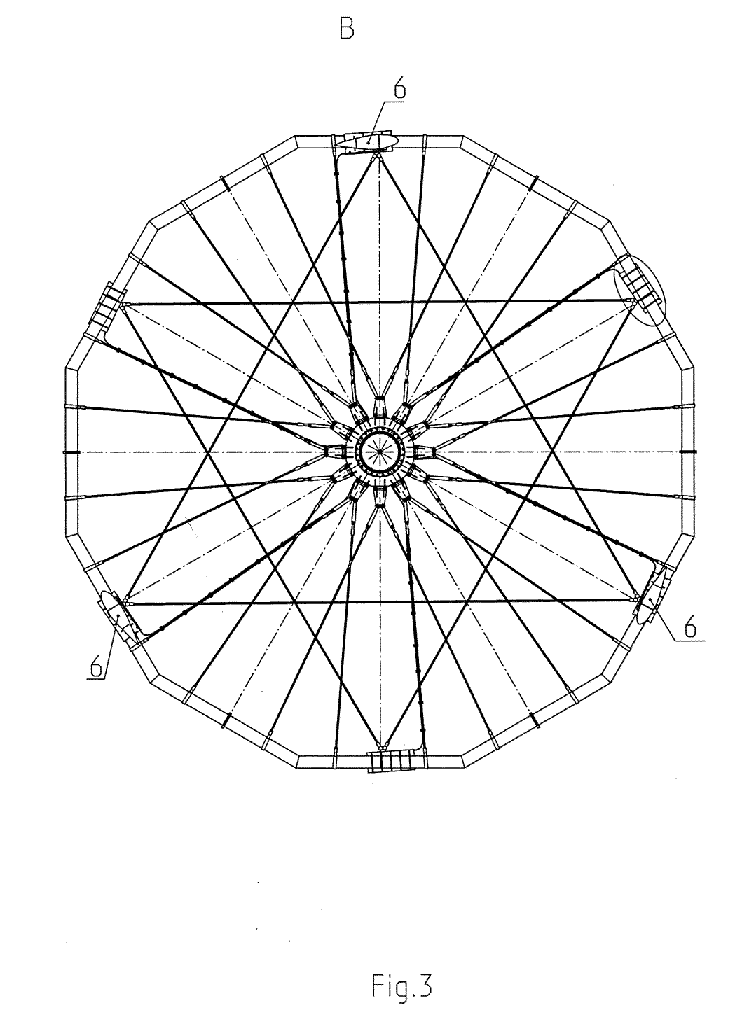

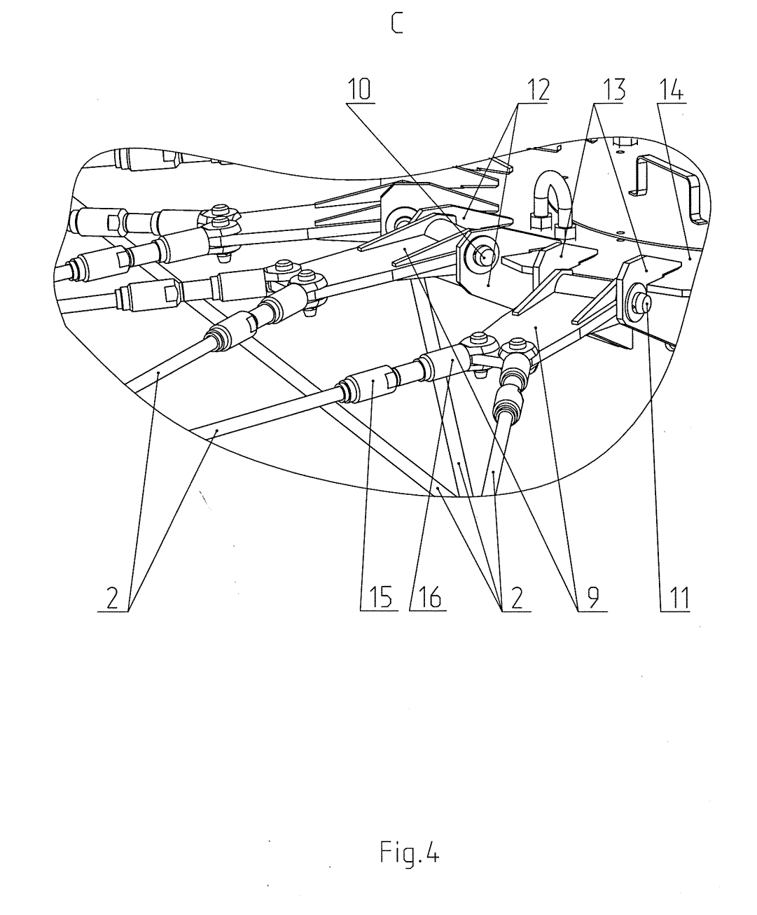

### DETAIL DESCRIPTION OF PREFERRED EMBODIMENTS OF THE INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as exemplified herein.

The rotor comprises a hub 1, coupled by flexible upper tensioning members 2 and flexible lower tensioning members 3 with a bearing ring 4. Blades 5 are mounted on the ring 4 forming an upper tier, while blades 6 are mounted on the bearing ring 4 forming a lower tier. The blades are mounted on the bearing ring equidistantly forming an angle of 120° therebetween, while the upper tier is shifted relatively to the lower tier at an angle of 60° therebetween. The free ends of the blades are coupled by flexible tensioning members 7.

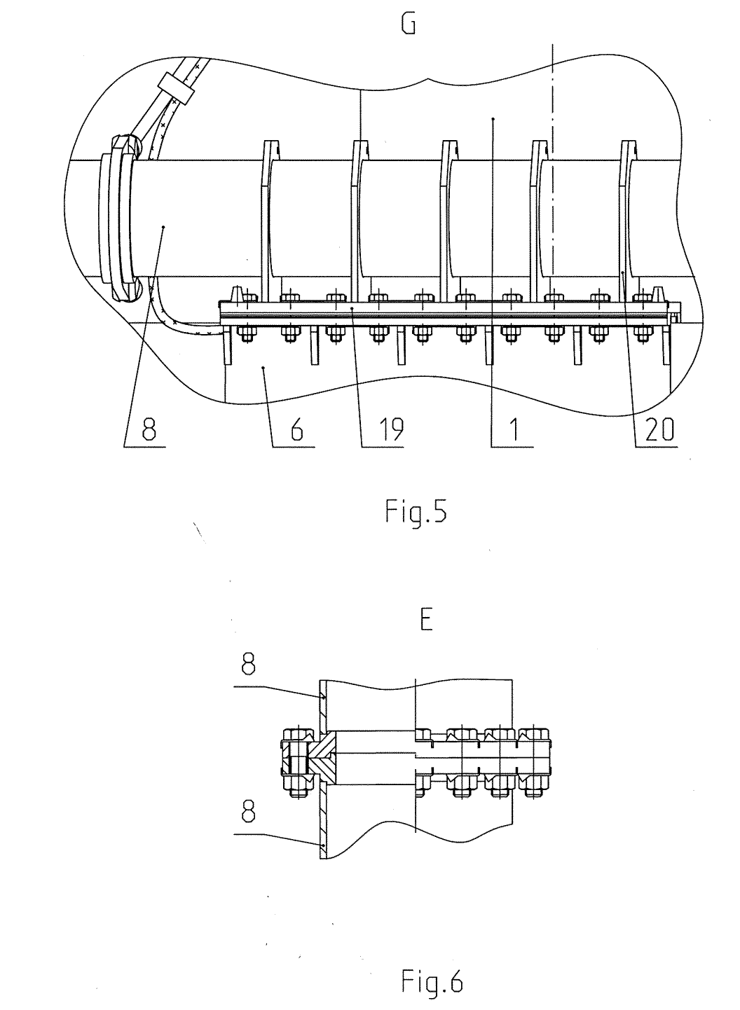

The tensioning members 2, 3, and 7 are made of a cable. The bearing ring 4 is made of a pipe, and includes a number of segments 8 attached by a flange coupling, shown on FIG. 5. The tensioning members 2, 3 are attached to the hub via rotatable plates 9 capable of turning about pivot pins 10, 11.

The pivot pins 10, 11 extend through consoles 12, 13, attached to an upper flange 14 of the hub 1, while the pivot pins 10, 11 are vertically spaced apart. Fastening assemblies of the tensioning members 2 and 3 are secured to the hub and vertically spaced apart at a height equal the height of the hub, which height is calculated based on optimization thereof taking into account the forces of the tensioning members.

The upper tensioning members 2 include a bushing 15 with threaded aperture receiving a treaded fork 16 forming a screw pair. In the lower tensioning members 3, a turnbuckle 17 is inserted between the bushing 15 and fork 16. Consoles 18 are mounted on segments 8, thus the consoles 18 support the tensioning members on the bearing ring 4. The blades 5 and 6 are attached to the bearing ring 4 through a nest 19 rigidly coupled with plates 20, which in turn rigidly coupled with the segments 8 of the bearing ring 4.

The nests 19 are situated at a certain angle to the longitudinal axes of segments 8. Four guiding rods 21 are mounted on the nest 19, which also includes a number of through holes for securing the blades.

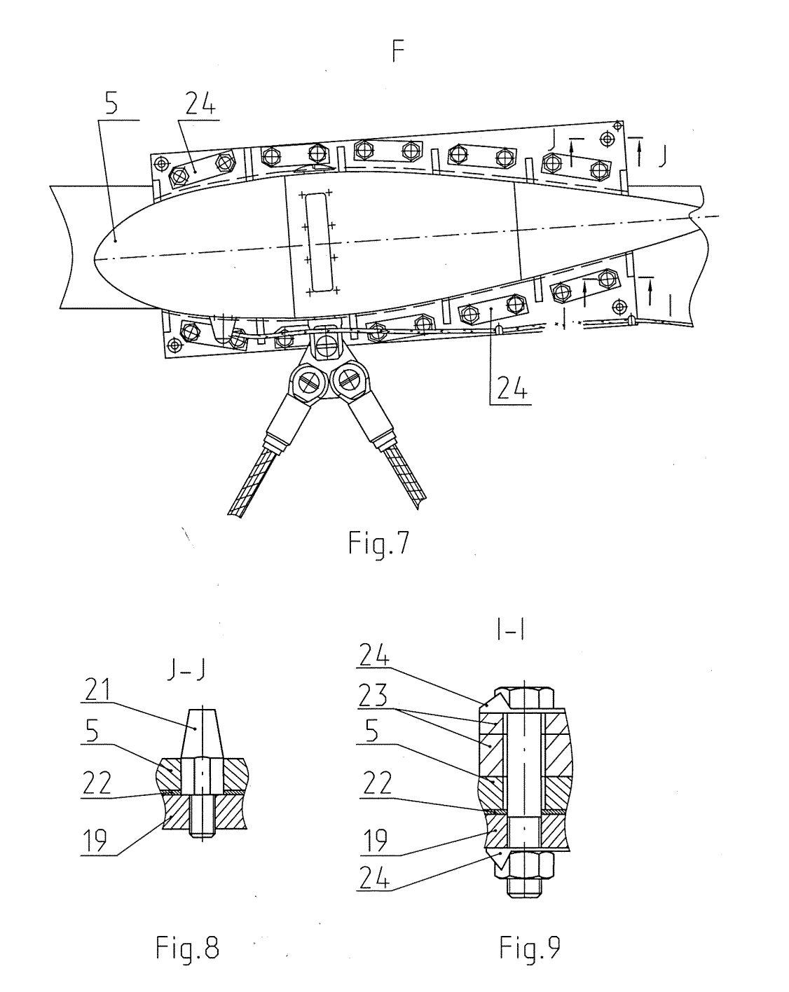

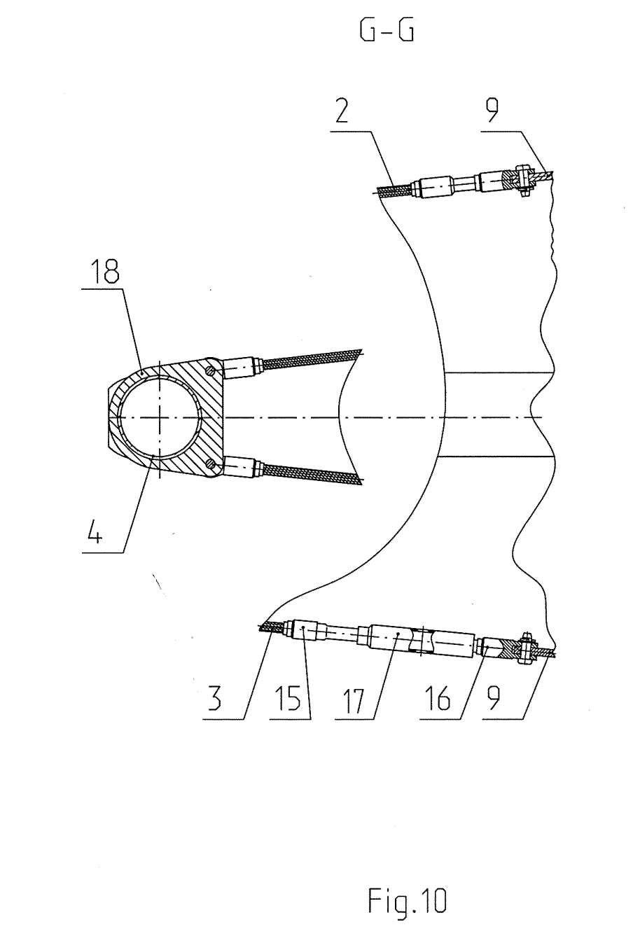

Fastening the blades to the nest 19 is carried out by bolt couplings, whereat an adjustment plate 22 is installed between the nest 19 and the blade; the adjustment plate has an outer diameter equal to the outer diameter of nest 19, while an inner contour of the adjustment plate is equal to the outer contour of the blade (FIG. 7).

A balance load 23 is installed in the bolt couplings, the balance load 23 is made in the form of plates with two holes, which two holes are used for receiving two neighboring bolts. Counter-screw plates 24 are employed for fixation of the bolts with respective nuts.

Assembling of the rotor is accomplished as follows. The hub 1 is placed on a low-height stand having a stand height. The bearing ring 4 is mounted under the hub 1 at a half of the stand height. The upper tensioning members 2 are aligned along the length with the help of bushing 15 and fork 16, and the upper tensioning members 2 are then fastened. Thereafter, the lower tensioning members are fastened with the help of turnbuckles 17 thereby providing a uniform tension of all of the tensioning members.

Since the pivot pins 10, 11 are mounted in the consoles 12, 13 and vertically spaced apart, the tensioning members cannot contact each other.

The blades 5, 6 are aligned with the help of the four guiding rods 21, then they are installed on the nests 19, secured with help of the bolt couplings, whereat the adjustment plates 22 are vertically positioned. The rotor is balanced with by means of the balance loads 23.

Since the blades 5, 6 are mounted on the bearing ring 4 at an angle to the tangent line at the point of mounting the blade, the rotor of the wind power installation can rotate under the action of wind.

The inventive rotor provides for reliable operation of the power wind installation, since, during a misbalance state of the rotor, its vibrations are not passed to the mast, due to damping the vibrations by the tensioning members.

### REFERENCES

R1. Russian Federation Patent RU2006668, priority: 18 Dec. 1989.
R2. Russian Federation Patent RU2024782, priority: 13 Mar. 1991.
R3. Russian Federation Patent RU2044157, priority: 31 Jul. 1992.
R4. Russian Federation Patent RU2045682, priority: 26 Mar. 1993.
R5. Russian Federation Patent RU2104408, priority: 25 May 1994.
R6. Russian Federation Patent RU2188335, priority: 18 Jun. 2001.
R7. Russian Federation Patent RU2347104, priority: 12 May 2006.

1. A rotor of a wind power installation with a vertical rotational axis, comprising: a hub located in a rotational center of the rotor, said hub includes fastening assemblies consisting of upper fastening assemblies and lower fastening assemblies; flexible tensioning members attached to said hub and mounted to said fastening assemblies; a bearing ring supporting a plurality of blades arranged in two tears; wherein the blades are attached to the hub by means of said flexible tensioning members, wherein the fastening assemblies are vertically spaced apart; wherein the tensioning members attached to the upper fastening assemblies are made lengthwise adjustable, and the tensioning members attached to the lower fastening assemblies are supplied with turnbuckles.

2. The rotor according to claim 1, wherein the bearing ring includes a number of segments.

3. The rotor according to claim 1, wherein the fastening assemblies of the tensioning members, are supplied with rotatable plates capable of turning about horizontal pivot pins, wherein the horizontal pivot pins, which are adjacent to each other, are spaced apart.
